(19) United States
(12) Patent Application Publication
(10) Pub. No.: US 2020/0217972 A1
(43) Pub. Date: Jul. 9, 2020

(54) VEHICLE POSE ESTIMATION AND POSE ERROR CORRECTION

(71) Applicant: QUALCOMM Incorporated, San Diego, CA (US)

(72) Inventors: Muryong KIM, Florham Park, NJ (US); Tianheng WANG, San Diego, CA (US); Suraj SWAMI, San Diego, CA (US); Jubin JOSE, Belle Mead, NJ (US)

(21) Appl. No.: 16/726,778

(22) Filed: Dec. 24, 2019

Related U.S. Application Data
(60) Provisional application No. 62/789,163, filed on Jan. 7, 2019.

(51) Int. Cl. G01S 19/53; G05D 1/02; G06K 9/00

(52) U.S. Cl. CPC G01S 19/53; G06K 9/00798; G05D 1/0274

(57) ABSTRACT

A method for vehicle positioning may include determining a first 6 degrees of freedom (6-DOF) pose of a vehicle, wherein the first 6-DOF pose may comprise a first altitude and one or more first rotational parameters indicative of a first orientation of the vehicle relative to a reference frame. A lane plane associated with a roadway being travelled by the vehicle may be determined based on the first 6-DOF pose and lane-boundary marker locations of lane-boundary markers on the roadway. For each lane-boundary marker, the corresponding lane-boundary marker location may be determined from a map, which may be based on the reference frame. A corrected altitude of the vehicle may then be determined based on the lane plane. A corrected 6-DOF pose of the vehicle may be determined based on the corrected altitude of the vehicle, the first 6-DOF pose, and an axis normal to the lane plane.

### CROSS REFERENCE TO RELATED APPLICATIONS

This application claims the benefit of and priority to U.S. Provisional Patent Application No. 62/789,163 filed Jan. 7, 2019, entitled “ VEHICLE POSE ESTIMATION AND POSE ERROR CORRECTION,” which is assigned to the assignee hereof and incorporated by reference in its entirety herein.

### FIELD

The subject matter disclosed herein relates generally to vehicle pose estimation and vehicle pose error correction.

### BACKGROUND

Autonomous driving systems (ADS) may be fully autonomous or partially autonomous. Partially autonomous driving systems include advanced driver-assistance systems (ADAS). ADS based vehicles, which are becoming increasingly prevalent, may use sensors to determine vehicle pose. The term vehicle pose refers to the position and orientation of a vehicle. Increasing position determination accuracy can facilitate ADS. However, positioning accuracy in conventional vehicle navigation systems may be less than desirable. For example, the positioning error in many conventional solutions based on Global Navigation Satellite System (GNSS) can be of the order of several meters, which can detrimentally impact ADS, cause navigation errors, and decrease passenger safety.

### SUMMARY

In some embodiments, a method for vehicle positioning may comprise: determining, at a first time, a first 6 degrees of freedom (6-DOF) pose of a vehicle, wherein the first 6-DOF pose comprises a first altitude and one or more first rotational parameters indicative of a first orientation of the vehicle relative to a reference frame; determining a lane plane associated with a roadway being travelled by the vehicle, wherein the lane plane is determined based on the first 6-DOF pose and lane-boundary marker locations of a plurality of lane-boundary markers on the roadway, wherein, for each lane-boundary marker of the plurality of lane-boundary markers, the corresponding lane-boundary marker location is determined from a map, wherein the map is based on the reference frame; and determining a corrected altitude of the vehicle based on the lane plane.

Disclosed embodiments also pertain to a vehicle comprising an image sensor, a Satellite Positioning System (SPS) receiver, a memory, and a processor coupled to the image sensor, SPS receiver, and memory, wherein the processor is configured to: determine, at a first time, a first 6 degrees of freedom (6-DOF) pose of the vehicle, wherein the first 6-DOF pose comprises a first altitude and one or more first rotational parameters indicative of a first orientation of the vehicle relative to a reference frame; determine a lane plane associated with a roadway being travelled by the vehicle, wherein the lane plane is determined based on the first 6-DOF pose and lane-boundary marker locations of a plurality of lane-boundary markers on the roadway, wherein, for each lane-boundary marker of the plurality of lane-boundary markers, the corresponding lane-boundary marker location is determined from a map, wherein the map is based on the reference frame; and determine a corrected altitude of the vehicle based on the lane plane.

Disclosed embodiments also pertain to a vehicle comprising: means for determining, at a first time, a first 6 degrees of freedom (6-DOF) pose of the vehicle, wherein the first 6-DOF pose comprises a first altitude and one or more first rotational parameters indicative of a first orientation of the vehicle relative to a reference frame; means for determining a lane plane associated with a roadway being travelled by the vehicle, wherein the lane plane is determined based on the first 6-DOF pose and lane-boundary marker locations of a plurality of lane-boundary markers on the roadway, wherein, for each lane-boundary marker of the plurality of lane-boundary markers, the corresponding lane-boundary marker location is determined from a map, wherein the map is based on the reference frame; and means for determining a corrected altitude of the vehicle based on the lane plane.

Disclosed embodiments also pertain to a computer-readable medium comprising instructions to configure a processor to: determine, at a first time, a first 6 degrees of freedom (6-DOF) pose of a vehicle, wherein the first 6-DOF pose comprises a first altitude and one or more first rotational parameters indicative of a first orientation of the vehicle relative to a reference frame; determine a lane plane associated with a roadway being travelled by the vehicle, wherein the lane plane is determined based on the first 6-DOF pose and lane-boundary marker locations of a plurality of lane-boundary markers on the roadway, wherein, for each lane-boundary marker of the plurality of lane-boundary markers, the corresponding lane-boundary marker location is determined from a map, wherein the map is based on the reference frame; and determine a corrected altitude of the vehicle based on the lane plane.

The methods disclosed may be performed by an ADS enabled vehicle based on images captured by an image sensor on vehicle, map data, information from other sensors, and may use protocols associated with wireless communications including cellular and vehicle to everything (V2X) communications. Embodiments disclosed also relate to software, firmware, and program instructions created, stored, accessed, read, or modified by processors using computer readable media or computer readable memory.

### BRIEF DESCRIPTION OF THE DRAWINGS

FIG. 1A illustrates an example scenario where positioning errors may occur in a conventional vehicle positioning system.

FIG. 1B illustrates the effect of positioning errors on a Visual Inertial Odometry (VIO) based navigation system.

FIG. 2 illustrates a system to facilitate ego vehicle pose determination in accordance with some disclosed embodiments.

FIGS. 3A and 3B show flowcharts of an example method to facilitate ego vehicle positioning in accordance with some disclosed embodiments.

FIG. 3C shows reference frames associated with an ego vehicle.

FIG. 3D shows a local crop of an HD map based on EN coordinates.

FIG. 3E shows altitude correction applied to an ego vehicle at a first 6-DOF pose comprising a first altitude.

FIG. 3F illustrates changes to axes associated with a body reference frame for an ego vehicle when a vertical axis is corrected.

FIG. 4 depicts an exemplary architecture of a system to facilitate vehicle pose determination in accordance with some disclosed embodiments.

FIG. 5 is a diagram illustrating an example of a hardware implementation of an ego vehicle capable of pose determination,

### DETAILED DESCRIPTION

Some disclosed embodiments pertain to the determination of an improved 6 Degrees of Freedom (6-DOF) pose of a subject vehicle or ego vehicle (hereinafter “ego vehicle”). A 6 Degrees of Freedom (6DoF) pose refers to three translation components (e.g. given by X, Y, and Z coordinates) and three angular components (e.g. roll, pitch and yaw). The pose of a UE may be expressed as a position or location, which may be given by (X, Y, Z) coordinates; and, an orientation, which may be given by angles (φ, θ, Ψ) relative to the axes of the frame of reference.

Positioning error in many conventional solutions based on Global Navigation Satellite System (GNSS) can be of the order of several meters, which can detrimentally impact navigation and passenger safety. High Definition (HD) map-based localization techniques can help improve positioning accuracy by correlating landmark features in an HD map (e.g. lane markings, traffic signs, etc.) with features observed in vehicle camera images at an estimated location of the vehicle. However, many HD map based techniques can be error prone due to: errors from positioning estimates, mapping errors, and unknown offsets between map based coordinates (e.g. a frame of reference used for the map) and global coordinate systems (e.g. used by GNSS, or other position determination techniques etc.). Global coordinate systems include Earth-Centered, Earth Fixed (ECEF), which is a terrestrial coordinate system) that rotates with the Earth and has its origin at the center of the Earth. Geographical frames of reference also include local tangent plane based frames of reference based on the local vertical direction and the earth's axis of rotation. For example, the East, North, Up (ENU) frame of reference may include three coordinates: a position along the northern axis, a position along the eastern axis, and a vertical position (above or below some vertical datum or base measurement point). Coordinate systems may specify the location of an object in terms of latitude, longitude, and altitude above or below some vertical datum) or other coordinates.

Conventional positioning techniques attempt to track vehicle 6-DOF pose, which can include position (x, y, z) and orientation (roll, pitch, yaw) relative to some frame of reference. However, conventional techniques focus on vehicle horizontal position (e.g. x, y) and vehicle heading (e.g. yaw), while ignoring or limiting observations related to vehicle vertical position (e.g. z), roll (e.g. φ), and pitch (e.g. θ). Thus, many conventional techniques suffer from pose inaccuracies that can detrimentally impact ADS solutions, navigation, and/or driver/passenger safety

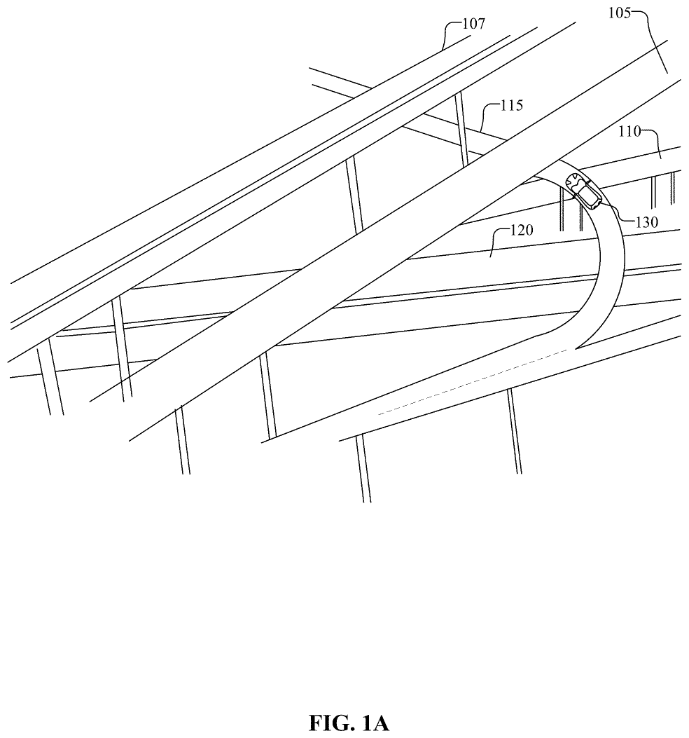

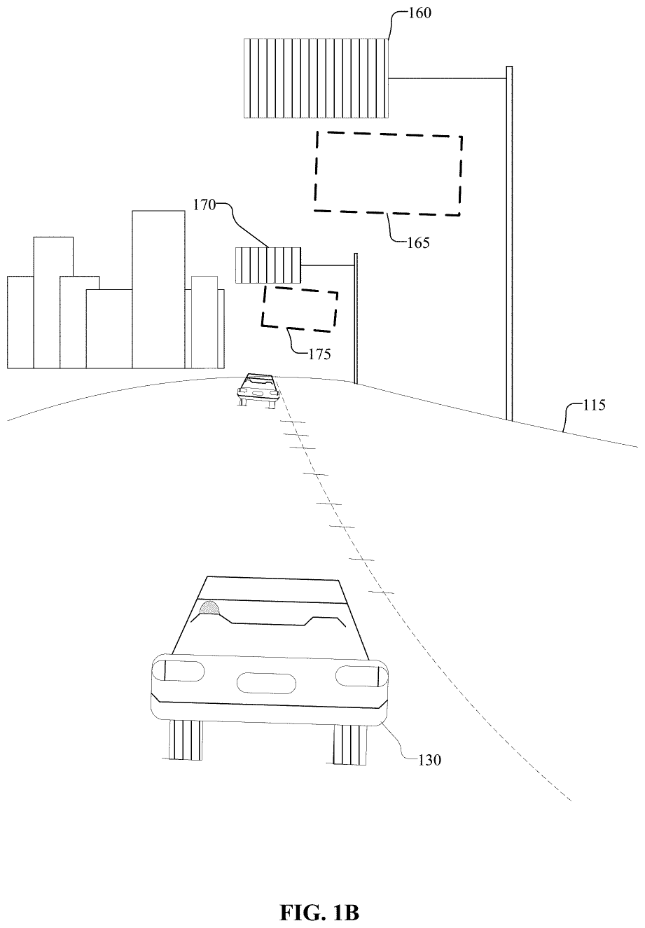

FIG. 1A shows a vehicle in a typical roadway interchange, which may involve several overpasses, underpasses, to facilitate vehicle movement between roadways. As shown in FIG. 1A, ego vehicle 130 may be on roadway 115 at a point in time. As shown in FIG. 1A, roadway 105 and roadway 107 pass over roadway 115, while roadway 110 and roadway 120 pass under roadway 115. Thus, errors in vertical positioning may make it difficult to determine the correct roadway on which ego vehicle 130 is currently travelling. An error in vertical position of a few meters could potentially place ego vehicle on the wrong roadway, which may result in incorrect directions and/or other errors.

FIG. 1B illustrates the effect of positioning errors on a Visual Inertial Odometry (VIO) based navigation system. VIO refers to the process of determining the position and orientation (or pose) and/or displacement (e.g. of an ego vehicle) by analyzing and comparing features in camera images captured at various points in time during UE movement. VIO may also use input from an Inertial Measurement Unit (IMU) to determine pose. In some embodiments, IMUs may include 3-axis accelerometer(s), 3-axis gyroscope(s), and/or magnetometer(s), which may provide measurements related to velocity, displacement, orientation, and/or other position related information

Measurements by a displacement sensor may provide, or be used to determine, a displacement (or baseline distance) between two locations occupied by a UE at different points in time and a “direction vector” or “direction” indicating a direction of the displacement between the two location relative to a specified frame of reference.

As shown in FIG. 1B, roadway 115, on which ego vehicle 130 may be travelling at a point in time, may include landmark features such as roadway sign 160 and roadway sign 170. A map used by the VIO based system on ego vehicle 130 may indicate the presence of roadway sign 160 and roadway sign 170. However, errors in vertical position, roll, and/or pitch may cause the VIO system to place roadway sign 160 and roadway sign 170 at location 165 and location 175, respectively. Thus, roadway sign 160 and roadway sign 170 may not be detected by the VIO system, which may lead to positioning and/or navigation errors.

Accordingly, some disclosed embodiments determine an accurate ego vehicle pose, including accurate position and orientation relative to a frame of reference. For example, the accurate ego vehicle pose may include an accurate vertical position estimate, an accurate ego vehicle pitch, and/or an accurate ego vehicle roll relative to a frame of reference.

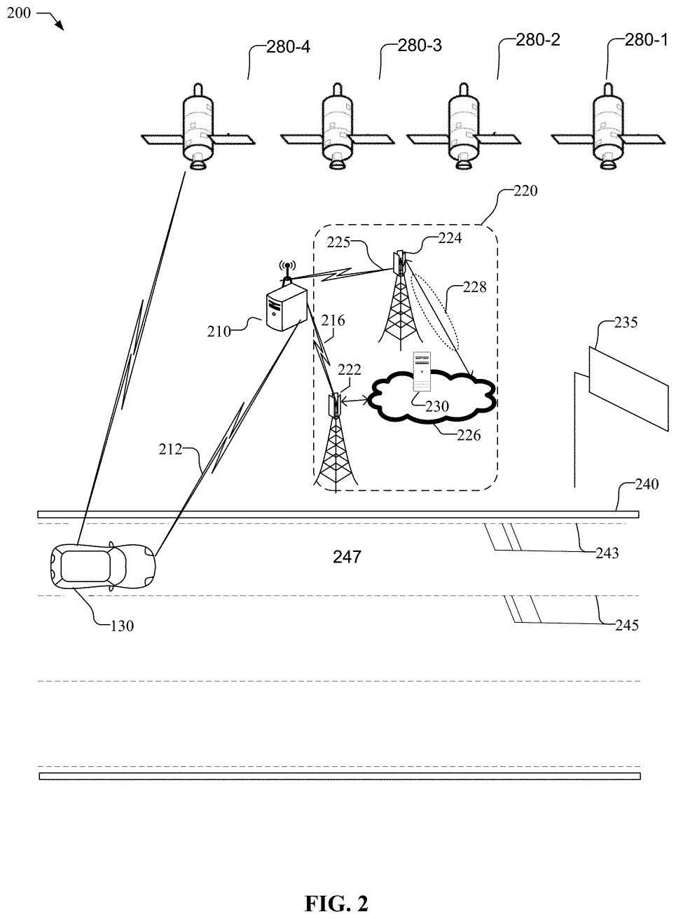

FIG. 2 illustrates a system to facilitate ego vehicle pose determination in accordance with some disclosed embodiments. For example, system 200 may facilitate or enhance position determination, navigation, and/or other ADS functions associated with an autonomous or semi-autonomous ego vehicle 130. In some embodiments, ego vehicle 130 may use information obtained from onboard sensors, including image sensors to enhance or augment ADS decision making. In some embodiments, the sensors may be mounted at various locations on the vehicle—both inside and outside.

In some embodiments, system 200 may use, for example, a Vehicle-to-Everything (V2X) communication standard, in which information may be passed between a vehicle (e.g. ego vehicle 130) and other entities coupled to a communication network 220, which may include wireless communication subnets. The V2X communication standard facilitates and provides a high degree of safety for pedestrians, moving vehicles, etc. V2X is a communication system in which information is passed between a vehicle and other entities within the wireless communication network that provides the V2X services.

V2X services may include, for example, one or more of services for: Vehicle-to-Vehicle (V2V) communications (e.g. between vehicles via a direct communication interface such as Proximity-based Services (ProSe) Direction Communication (PC5) (e.g. as defined in Third Generation Partnership Project (3GPP) TS 23.303) and/or Dedicated Short Range Communications (DSRC)), Vehicle-to-Pedestrian (V2P) communications (e.g. between a vehicle and a User Equipment (UE) such as a mobile device), Vehicle-to-Infrastructure (V2I) communications (e.g. between a vehicle and a base station (BS) or between a vehicle and a roadside unit (RSU)), and/or Vehicle-to-Network (V2N) communications (e.g. between a vehicle and an application server). An RSU may be a logical entity that may combine V2X application logic with the functionality of a base station such as an evolved NodeB (eNB) or next Generation nodeB (gNB). One mode of operation may use direct wireless communications between V2X entities when the V2X entities are within range of each other. Another mode of operation may use network based wireless communication between V2X entities. The modes of operation for V2X above may be combined or other modes of operation may be used if desired.

The V2X standard may be viewed as facilitating ADS including ADAS. Depending on capabilities, an ADS may make driving decisions (e.g. navigation, lane changes, determining safe distances between vehicles, cruising/overtaking speed, braking, parking, etc.) and/or provide drivers with actionable information to facilitate driver decision making. In some embodiments, V2X may use low latency communications thereby facilitating real time or near real time information exchange and precise positioning. As one example, positioning techniques, such as one or more of: Satellite Positioning System (SPS) based techniques (e.g. based on space vehicles 280) and/or cellular based positioning techniques such as time of arrival (TOA), time difference of arrival (TDOA) or observed time difference of arrival (OTDOA), may be enhanced using V2X assistance information. V2X communications may thus help in achieving and providing a high degree of safety for moving vehicles, pedestrians, etc.

Disclosed embodiments also pertain to the use of information obtained from one or more sensors such as image sensors, ultrasonic sensors, radar, etc. (not shown in FIG. 2) coupled to ego vehicle 130 to facilitate or enhance ADS decision making. For example, in some embodiments, ego vehicle 130 may use images obtained by onboard image sensors to facilitate or enhance ADS decision making. Image sensors may include cameras, CMOS sensors, CCD sensors, and light detection and ranging sensors (hereinafter “lidar”). In some embodiments, image sensors may include depth sensors. Information from vehicular sensors (e.g. image sensors or other sensors) in ego vehicle 130 may also be useful to facilitate autonomous driving/decision making. In some embodiments, the image sensors may form part of a VIO system associated with ego vehicle 130. In VIO, several visual features may be tracked from frame to frame, which may be used to determine an accurate estimate of relative vehicle motion and/or vehicle position. For example, visual features (such as landmarks visible from a roadway) may be tracked and used to determine vehicle location by correlating the visual features with the locations of corresponding features on a map (e.g. an HD map).

Image sensors may include cameras, charge coupled device (CCD) based devices, or Complementary Metal Oxide Semiconductor (CMOS) based devices, Lidar, computer vision devices, etc. on a vehicle, which may be used to obtain images of an environment around the vehicle. Image sensors, which may be still and/or video cameras, may capture a series of 2-Dimensional (2D) still and/or video image frames of an environment. In some embodiments, image sensors may take the form of a depth sensing camera, or may be coupled to depth sensors. The term “depth sensor” is used to refer to functional units that may be used to obtain depth information. In some embodiments, image sensors may comprise Red-Green-Blue-Depth (RGBD) cameras, which may capture per-pixel depth (D) information when the depth sensor is enabled, in addition to color (RGB) images. In one embodiment, depth information may be obtained from stereo sensors such as a combination of an infra-red structured light projector and an infra-red camera registered to a RGB camera. In some embodiments, image sensors may be stereoscopic cameras capable of capturing 3 Dimensional (3D) images. For example, a depth sensor may form part of a passive stereo vision sensor, which may use two or more cameras to obtain depth information for a scene. The pixel coordinates of points common to both cameras in a captured scene may be used along with camera parameter information, camera pose information and/or triangulation techniques to obtain per-pixel depth information. In some embodiments, image sensor may include lidar, which may provide measurements to estimate the relative distance of objects. The term “camera pose” or “image sensor pose” is also used to refer to the position and orientation of an image sensor on an ego vehicle. Because the orientations of the image sensor(s) relative to the ego vehicle body can be known, image sensor pose may be used to determine ego vehicle pose.

As shown in FIG. 2, communication network 220 may operate using direct or indirect wireless communications between ego vehicle 130 and other entities, such as Application Server (AS) 210 and/or one or more other vehicles with V2X/V2V functionality. For example, the wireless communication may occur over, e.g., Proximity-based Services (ProSe) Direction Communication (PC5) reference point as defined in 3GPP TS 23.303, and may use wireless communications under IEEE 1609, Wireless Access in Vehicular Environments (WAVE), Intelligent Transport Systems (ITS), and IEEE 802.11p, on the ITS band of 5.9 GHz, or other wireless connections directly between entities. The V2X communications based on direct wireless communications between the V2X entities do not require any network infrastructure for the V2X entities to directly communicate and enable low latency communications, which can be advantageous for precise positioning. Accordingly, in some embodiments, such direct wireless V2X communications may be used to enhance the performance of current Wireless Wide Area Network (WWAN) or Wireless Local Area Network (WWAN) based positioning techniques, such as Time of Arrival (TOA), Time Difference of Arrival (TDOA), Observed Time Difference of Arrival (OTDOA), etc.

Accordingly, as shown in FIG. 2, ego vehicle 130 may communicate with and/or receive information from various entities coupled to wireless network 220. For example, ego vehicle 130 may communicate with and/or receive information from AS 210 or cloud-based services over V2N. As another example, ego vehicle 130 may communicate with RSU 222 over communication link 223. RSU 222 may be a Base Station (BS) such as an eNB/gNB, or a roadside device such as a traffic signal, toll, or traffic information indicator. As shown in FIG. 2, RSU 222 may include functionality to connect via Internet Protocol layer 226 and subnet 228 to BS 224. BS 224 (e.g. an eNB/gNB) may communicate via Uu interface 225 with AS 210 and/or with other vehicles via a Uu interface (not shown). Further, BS 224 may facilitate access by AS 210 to cloud based services or AS 230 via Internet Protocol (IP) layer 226 and network 220.

In some embodiments, ego vehicle 130 may access AS 210 over V2I communication link 212. AS 210, for example, may be an entity supporting V2X applications that can exchange messages (e.g. over V2N links) with other entities supporting V2X applications. AS 210 may wirelessly communicate with BS 224, which may include functionality for an eNB and/or a gNB. For example, in some embodiments, AS 210 may provide information in response to queries from an ADS system and/or an application associated with an ADS system in ego vehicle 130.

AS 110 (and/or AS 130) may be used to provide vehicle related information to vehicles including ego vehicle 130. In some embodiments, AS 110 and/or AS 130 and/or cloud services associated with network 120 may provide map information to ego vehicle 130. The term “map” is used to refer to maps of various kinds, including HD maps. The map information may relate to an area around a current location of ego vehicle 130, or may include areas around a planned route for a trip by ego vehicle 130. In some embodiments, the map may be a HD map, which may include positions of roadway landmarks such as roadway sign 235, lanes, lane markers on roadway 240, including lane-boundary markers associated lane 247 on which ego vehicle 130 may be travelling. The HD map may include information relating to lane-boundary markers such as left lane-boundary markers 243 (relative to a direction of travel of ego vehicle 130) and right lane-boundary markers 245 (relative to a direction of travel of ego vehicle 130). Landmarks may be any visual features visible from a roadway (e.g. roadway 240) including road signs, traffic signs, traffic signals, billboards, mileposts, etc. The right lane boundary (relative to a direction of travel of ego vehicle 130) may be defined by a sequence of right lane-boundary markers (e.g. right lane-boundary markers 245), while the left lane (relative to a direction of travel of ego vehicle 130) may be defined by a sequence of left lane-boundary markers (e.g. left lane-boundary markers 243). The area between the left and right lane boundaries may constitute a lane (e.g. lane 240) on which a vehicle (e.g. ego vehicle 130) is travelling. Information about lane-boundary markers on a HD map may include identification information for a lane-boundary marker and information about the position of the lane-boundary marker (e.g. from some defined starting position). An area in lane 247 proximate to and/or including a current location of ego vehicle 130 may form a lane plane associated with roadway 240, lane 247, and/or a current location of ego vehicle 130. The term “lane plane” is used to refer to a section of a road lane around a current location ego-vehicle 130, which may assumed to be planar.

In some embodiments, ego vehicle 130 may include onboard map databases that may store maps, including HD maps of an area around a current location of ego vehicle 130 and/or of an area including some route travelled by ego vehicle 130. In some embodiments, the database(s) coupled to ego vehicle 130 and/or AS 210/230 may be updated periodically by a map or service provider. An HD map may be a high precision map (e.g. with decimeter or sub-decimeter level accuracy) that identifies a plurality of roadway features. HD maps may include information about landmarks, lanes, lane-boundary markers, etc. and may be in digital form. The HD map may be stored on ego vehicle 130 and/or obtained by ego vehicle 130 (e.g. from AS 210/230 or a service provider).

Additionally, as shown in FIG. 2, entities coupled to communication network 220 may communicate using indirect wireless communications, e.g., using a network based wireless communication between entities, such as Wireless Wide Area Networks (WWAN). For example, entities may communicate via the Long Term Evolution (LTE) network, where the radio interface between the user equipment (UE) and the eNodeB is referred to as LTE-Uu, or other appropriate wireless networks, such as “3G,” “4G,” or “5G” networks. In addition, entities (e.g. ego vehicle 130) coupled to communication network 220 may receive transmissions that may be broadcast or multicast by other entities coupled to the network. As illustrated, the ego vehicle 130 may wirelessly communicate with various other V2X entities, such as the AS 210 through a network infrastructure 220, which, for example, may be a 5G network. When communication network 220 is a 5G network, a 5G capable ego vehicle 130, for example, may wirelessly communicate with BS 224 (e.g. a gNB) or RSU 222 via an appropriate Uu interface.

In some implementations, RSU 222 may directly communicate with the AS 210 via communication link 216. RSU 222 may also communicate with other base stations (e.g. gNBs) 224 through the IP layer 226 and network 228, which may be an Evolved Multimedia Broadcast Multicast Services (eMBMS)/Single Cell Point To Multipoint (SC-PTM) network. AS 230, which may be V2X enabled, may be part of or connected to the IP layer 226 and may receive and route information between V2X entities in FIG, 2 and may also receive other external inputs (not shown in FIG. 2).

Ego vehicle 130 may also receive signals from one or more Earth orbiting Space Vehicles (SVs) 280 such as SVs 280-1, 280-2, 280-3, and/or 280-4 collectively referred to as SVs 280, which may be part of a Global Navigation Satellite System. SVs 280, for example, may be in a GNSS constellation such as the US Global Positioning System (GPS), the European Galileo system, the Russian Glonass system, or the Chinese Compass system. In accordance with certain aspects, the techniques presented herein are not restricted to global satellite systems. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS/GNSS may include any combination of one or more global and/or regional navigation satellite systems and/or augmentation systems, and SPS/GNSS signals may include SPS, SPS-like, and/or other signals associated with such one or more SPS/GNSS. The SPS/GNSS may also include other non-navigation dedicated satellite systems such as Iridium or OneWeb. In some embodiments, ego vehicle 130 may be configured to receive signals from one or more of the above SPS/GNSS/satellite systems.

In some embodiments, available GNSS measurements (which may include carrier phase measurements) that meet quality parameters may be used in conjunction with VIO. For example, available GNSS measurements may be used to determine a first location of ego vehicle 130, which may be further refined based on VIO (e.g. correlating observed features with an HD map).

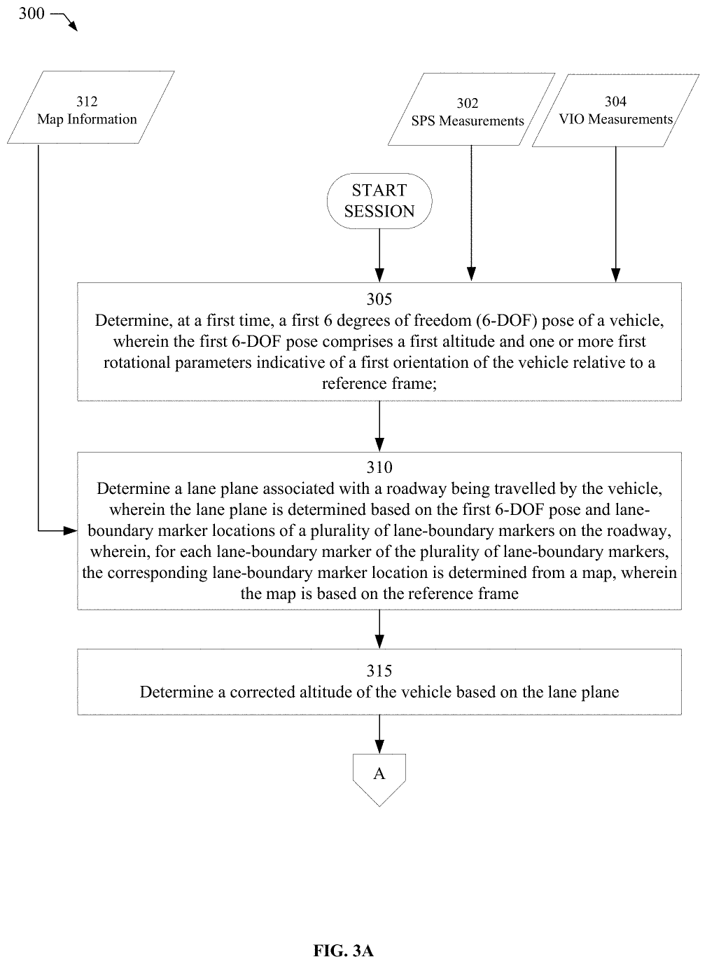

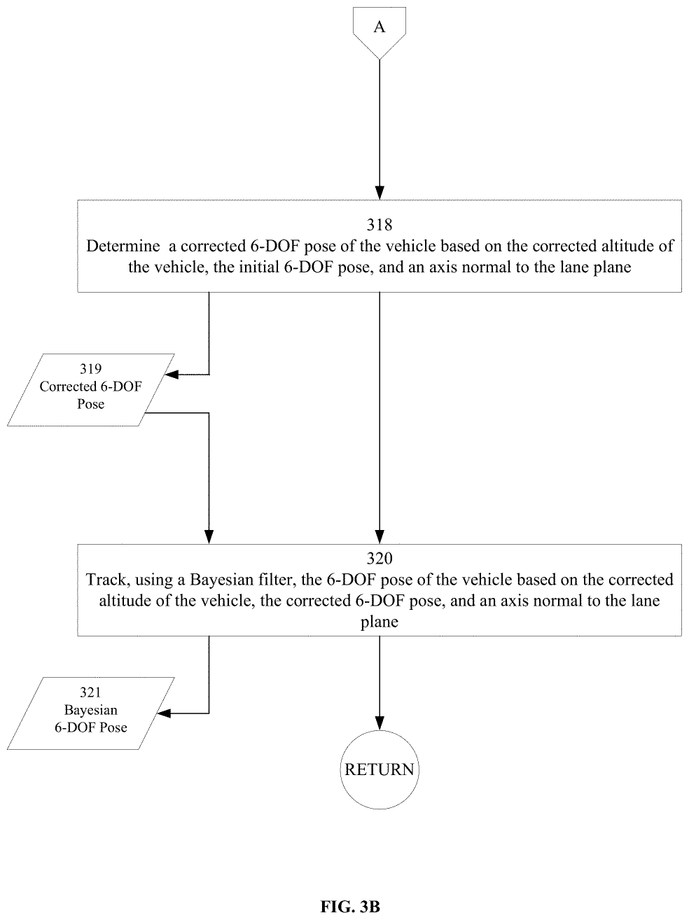

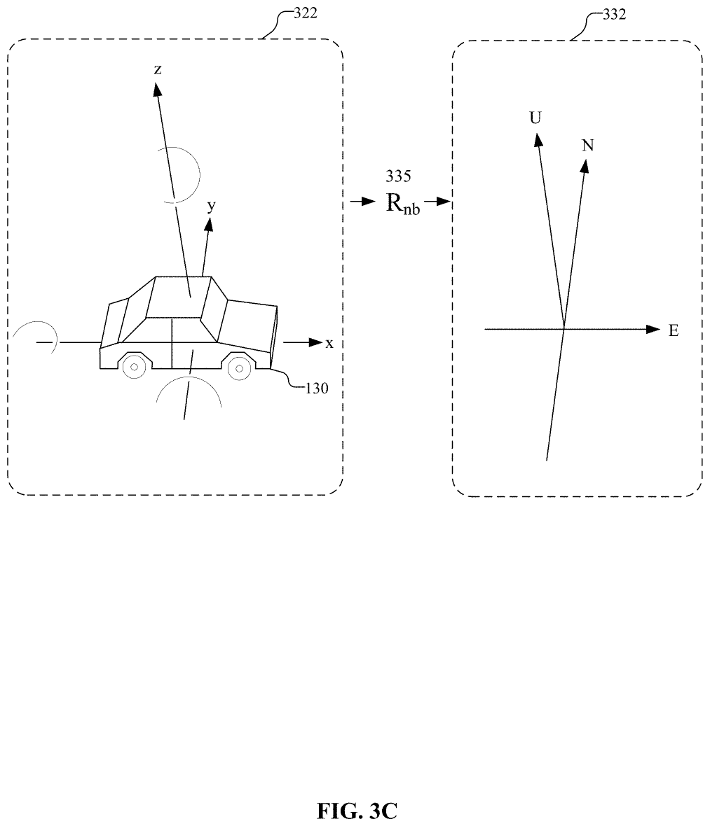

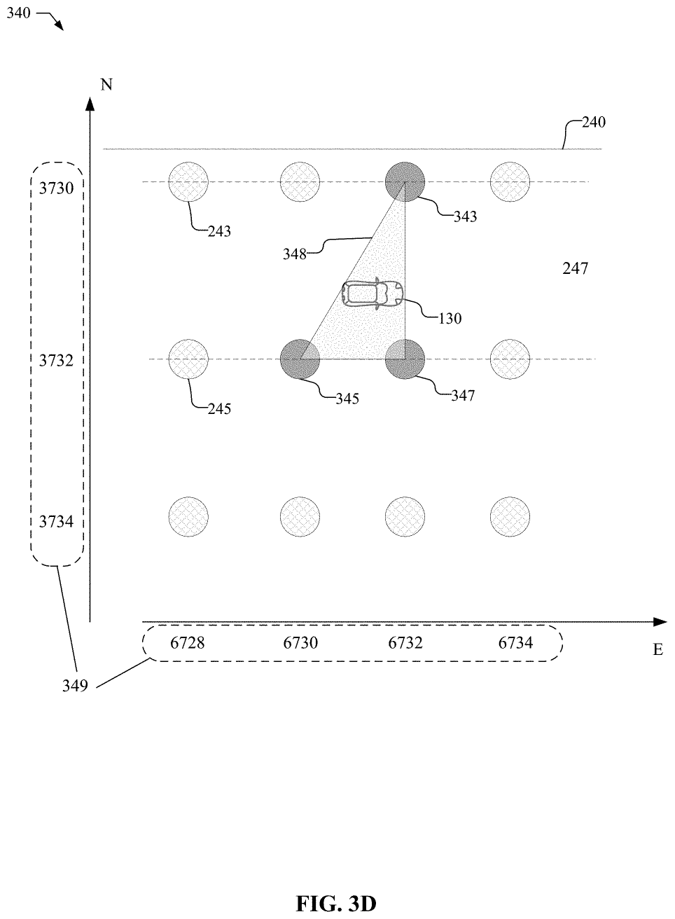

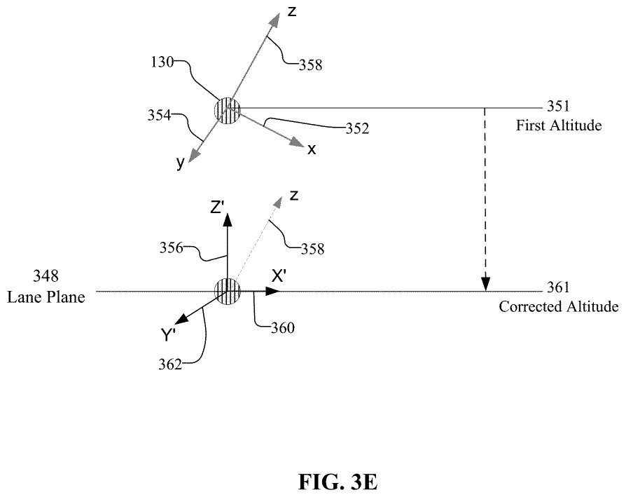

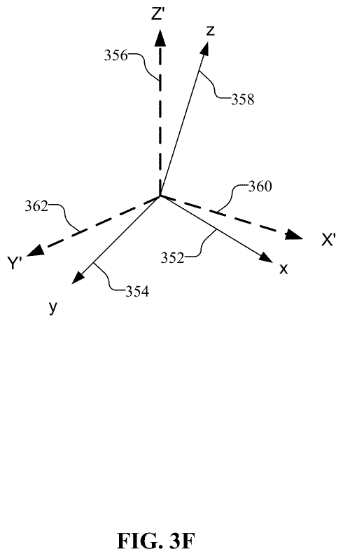

FIGS. 3A and 3B show flowcharts of an example method 300 to facilitate ego vehicle positioning in accordance with some disclosed embodiments. In some embodiments, method 300 may be performed by ego vehicle 130 or an ADS associated with ego vehicle 130 using one or more processors (e.g. on board ego vehicle 130). In some embodiments, method 300 may use one or more of: (a) information obtained from a VIO system on ego vehicle 130, which may include image sensors and Inertial Measurement Unit (IMU) sensors, (b) map information (e.g. from an HD map), and/or (c) SPS position information (e.g. from an SPS receiver on ego vehicle 130). In some embodiments, map information may be stored (e.g. in a map database) on ego vehicle 130 and/or obtained by ego vehicle over V2X (e.g. received from entity coupled to network 120). SPS position information may be received from SVs 280 using an SPS receiver coupled to ego vehicle 130.

In block 305, a first 6 degrees of freedom (6-DOF) pose of a vehicle (e.g. ego vehicle 130) may be determined. The first 6-DOF pose may comprise a first altitude and one or more first rotational parameters to determine an orientation of the vehicle relative to a reference frame. In some embodiments, the first 6-DOF pose of the vehicle may be determined based on one or more of: a SPS measurements a 302 and/or Visual Inertial Odometry (VIO) measurements 304.

In some embodiments, determination of the first 6-DOF pose of the vehicle may be based additionally on input from WWAN and/or WLAN signal measurements. WWAN/WLAN signal measurements may include measurements of positioning related signals (e.g. Positioning Reference Signals (PRS) transmitted by base stations), and/or Observed Time Difference of Arrival (OTDOA) measurements, and/or Reference Signal Time Difference (RSTD) measurements, Round Trip Time (RTT) measurements, and/or Time of Arrival (TOA) measurements, and/or Received Signal Strength Indicator (RSSI) measurements, and/or Advanced Forward Link Trilateration (AFLT) measurements. Some combination of the above measurements may be used to determine or inform determination of the first 6-DOF pose of ego vehicle 130.

In some embodiments, the first rotational parameters (e.g. comprised in the first 6-DOF pose) may describe the orientation of a first reference frame (e.g. a body reference frame centered on the ego vehicle's body) relative to the (second) reference frame used to specify the 6-DOF pose. The second reference frame may be a geographic reference frame such as an ENU reference frame or and ECEF reference frame. The 6-DOF pose may also include horizontal position information for ego vehicle 130.

FIG. 3C shows reference frames associated with ego vehicle 130. The first reference frame or body reference frame 322 is defined by x (e.g. forward), y (e.g. left), and z (e.g. up) orthogonal axes centered on the vehicle body. FIG. 3C also shows a second geographical reference frame given by ENU reference frame 332, which is defined by the East, North, and Up orthogonal axes. The orientation of ego vehicle 130 may be specified using first rotational parameters, which define orientation of the body reference frame 322 relative to the ENU reference frame 332.

The first rotational parameters that describe the rotation of body reference frame 322 relative to the ENU reference frame 332 may be represented, for example, by R_{nb} 335, where R_{nb}=[r₁ r₂ r₃], where r₁, r₂, and r₃ are each column vectors (e.g. 3 rows and 1 column) describing rotations of the x, y, and z axes relative to the E, N, and U axes, respectively.

Referring to FIG. 3A, in block 310, a lane plane associated with a roadway or lane (e.g. roadway 240 or lane 247, respectively) being travelled by the vehicle (e.g. ego vehicle 130) may be determined.

In some embodiments, the lane plane (e.g. associated with lane 247 in FIG. 2) may be identified based on the first 6-DOF pose (e.g. as determined in block 305) and lane-boundary marker locations of a plurality of lane-boundary markers on the roadway. For example, the locations corresponding to each of the lane-boundary markers may be determined from a map. In some embodiments, the map may use or be based on the (second—e.g. ENU) reference frame in block 305. The lane plane may be determined based on the locations of lane-boundary markers around ego vehicle 130.

FIG. 3D shows a portion or local crop of an HD map 340 based on EN coordinates. FIG. 3D depicts the location of ego vehicle 130 on roadway 240 along with left lane-boundary markers 243 and right lane-boundary markers 245 for lane 247, on which ego vehicle 130 may be travelling. As shown in FIG. 3D, left lane-boundary markers 243 include left lane-boundary marker 343, while right lane-boundary markers 245 include right lane-boundary marker 345 and right lane-boundary marker 347. Left lane-boundary marker 343, right lane-boundary marker 345, and right lane-boundary marker 347 may be proximate to a location of ego vehicle 130 at a point in time. HD map 340 includes coordinates 349 that may provide an indication of the location of each boundary marker (e.g. lane-boundary markers 343, 345, and 347) in EN coordinates. Lane-boundary markers around ego vehicle 130 may be sensed, and/or images of the lane-boundary markers may be captured using image sensors or other sensors on ego vehicle 130.

In some embodiments, a local crop of the map may be obtained (e.g. within some distance around ego vehicle 130). The various lane-boundary markers (e.g. 243, 245, etc.) in the local map may be determined. Further, the lane-boundary markers may be partitioned into two sets, egoLeft and egoRight. The egoLeft set may include left lane-boundary markers 243, which are to the left of the vehicle based on vehicle heading and lane direction. Similarly, egoRight may include right lane-boundary markers 245, which are to the right of the vehicle based on vehicle heading and lane direction. Lane boundaries (right and left) associated with lane 247 may be recovered using well known line fitting methods based on the known coordinates of the lane-boundary markers and the first position of ego vehicle 130 (e.g. from block 305). In some embodiments, point to line distance determination may be used to determine the nearest lane boundaries based on the position of the vehicle and the line equations associated with the lane boundaries.

In some embodiments, left lane-boundary marker 343, right lane-boundary marker 345, and right lane-boundary marker 347 may be used to determine a lane plane 348 associated with roadway 240 at (or proximate to) the current location of ego vehicle 130. For example, as shown in FIG. 3D, the lane-boundary markers selected at point in time (e.g. left lane-boundary marker 343, right lane-boundary marker 345, and right lane-boundary marker 347) to determine lane plane 348 may be based on a position of ego vehicle 130 at that point in time. In some embodiments, the lane plane may be determined as a plane equation based on three or more lane boundary points. For example, a lane plane equation may be determined based on the location of left lane-boundary marker 343, the location of right lane-boundary marker 345, and the location of right lane-boundary marker 347.

In some embodiments, selected lane-boundary markers (e.g. to determine the lane plane) may be validated to ensure that the area of a triangle defined by three lane-boundary markers exceeds some threshold (e.g. to decrease the sensitivity of the determined plane/plane equation to map error). Various well-known plane fitting methods may be used to determine the equation of the lane plane (e.g. the lane plane corresponding to the section of roadway 240 proximate to ego vehicle 130). For example, when more than three lane boundary points are used to determine the lane plane, well-known plane fitting methods such as least squares fitting may be used to determine the equation of the lane plane (e.g. the lane plane corresponding to the section of roadway 240 proximate to ego vehicle 130).

Referring to FIG. 3A, in some embodiments, in block 315, a corrected altitude of the vehicle (e.g. ego vehicle 130) may be determined based on the lane plane (e.g. as determined in block 310).

In some embodiments, upon determination of the lane plane (e.g. the lane plane corresponding to the section of roadway 240 proximate to ego vehicle 130), ego vehicle 130 may be situated or placed on the plane thereby correcting the first altitude determined in block 305. Because ego vehicle 130 is travelling on roadway 240, ego vehicle 130 is on the lane plane and may be placed on the plane. In some embodiments, the altitude of ego vehicle 130 may be corrected by projecting the estimated position (e.g. based on the first altitude determined in block 305) onto the lane plane.

FIG. 3E shows ego vehicle 130 at first 6-DOF pose with first altitude 351. FIG. 3E also shows a body reference frame centered on ego-vehicle 130 with x-axis 354, y-axis 352, and z-axis 358. As shown in FIG. 3E, upon determination of lane plane 348 (e.g. in block 310) ego vehicle 130 may be placed on lane plane 348 (e.g. by projecting ego vehicle 130 onto lane plane 348 based on its first 6-DOF pose/first altitude 351) resulting in a corrected altitude 361. In some instances, as a consequence of the projection onto lane plane 348, z-axis 358 may no longer be orthogonal to axis X′-axis 360 and Y′-axis 362 drawn along lane plane 348.

Referring to FIG. 3B, in some embodiments, method 300 may further comprise block 318, where a corrected 6-DOF pose 319 of the vehicle (e.g. ego vehicle 130) may be determined based on the corrected altitude 361. For example, a corrected 6-DOF pose 319 of the vehicle (e.g. ego vehicle 130) may be determined based on the corrected altitude 361 of the vehicle and an axis normal to the lane plane (e.g. Z′-axis 356 in FIG. 3E). In some embodiments, the corrected 6-DOF pose 319 of the vehicle may be input to a Visual Inertial Odometry (VIO) system (e.g. in block 305) coupled to the vehicle during a subsequent iteration.

In some embodiments, the corrected 6-DOF pose (e.g. as determined in block 318) of the vehicle (e.g. ego vehicle 130) may comprise second rotational parameters to determine an orientation of the vehicle relative to the (second—e.g. ENU) reference frame. In some embodiments, the second rotational parameters may be determined using a Gram-Schmidt technique.

For example, when ego vehicle 130 is on lane plane 348, the new vertical axis (Z′-axis 356) in the body reference frame is normal to the lane plane. That is, the vertical axis (Z′ 356) associated with the body reference frame is perpendicular to the local lane plane 348 (e.g. as determined from the local map based on left lane-boundary marker 343, right lane-boundary marker 345, and right lane-boundary marker 347). Thus, lane plane 348 (e.g. plane equation determined in block 310) may be used to obtain the plane normal vector, which can be used as the new vertical axis (Z′) in the body reference frame and the Gram-Schmidt technique may be used to recover orthogonality of the axes and obtain X′-axis 360 and Y′-axis 362.

FIG. 3F illustrates changes to axes associated with a body reference frame for ego vehicle 130 when a vertical axis is corrected. FIG. 3F shows x-axis 352, y-axis 354, and a vertical axis—shown as z-axis 358, which are mutually orthogonal and associated with body reference frame 322. When the vertical position of the vehicle is updated and vector normal to the lane plane is used as the new vertical axis, which is shown as Z′-axis 356, then Z′-axis 356, x-axis 352, and y-axis 354 are no longer mutually orthogonal. In some embodiments, in block 318, orthogonality relative to the new vertical axis, shown as Z′-axis 356, may be recovered using the Gram-Schmidt process to obtain X′-axis 360 and Y′-axis 362 as described below.

Mathematically, if the third column r₃, in R_{nb}=[r₁ r₂ r₃], is replaced with plane normal vector v₃, then, r₁, r₂, and v₃ may no longer be orthogonal. Orthogonality of the axes may be determined by comparing r₃ with

$$\frac{{v}_{3}}{‖ {v}_{3} ‖} .$$

If the terms r₃ and

$$\frac{{v}_{3}}{‖ {v}_{3} ‖}$$

are equal, then, the axes are orthogonal. Otherwise, orthogonality may be recovered using the Gram-Schmidt process or other well-known techniques.

For example, if ax+by+cz+d=0 is the equation of the lane plane, then, v₃=[a b c]^{T} is the normal vector perpendicular to the lane plane, where T denotes the transpose of the matrix. By applying the Gram-Schmidt process, a new rotation matrix that correctly orients the vehicle (e.g. ego vehicle 130) relative to the second reference frame may be determined. The new orthogonal axes may be determined to obtain second (corrected) rotational parameters that reflect the correct orientation of the vehicle (e.g. ego vehicle 130) relative to the second reference frame. The second rotational parameters may be obtained as

$${R}_{nb}^{′} = [ \frac{{v}_{1}}{‖ {v}_{1} ‖} \frac{{v}_{2}}{‖ {v}_{2} ‖} \frac{{v}_{3}}{‖ {v}_{3} 〛} ] , where$$

$${v}_{1} = {r}_{1} - \frac{( {r}_{1}^{T} {v}_{3} ) {v}_{3}}{{‖ {v}_{3} ‖}^{2}} and {v}_{2} = {r}_{2} - \frac{( {r}_{2}^{T} {v}_{3} ) {v}_{3}}{{‖ {v}_{3} ‖}^{2}} - \frac{( {r}_{2}^{T} {v}_{1} ) {v}_{1}}{{‖ {v}_{1} ‖}^{2}} .$$

In some embodiments, the corrected 6-DOF pose 319 of the vehicle (e.g. ego vehicle 130) may be determined based on R′_{nb}.

In some embodiments, in block 320, the vehicle pose may be tracked over time using a Bayesian filter such as an Extended Kalman Filter (EKF). In embodiments where the vehicle pose may be tracked using a Bayesian filter such as EKF, the second rotational parameters associated with the corrected 6-DOF pose may be input as an observation vector to update the filter states.

For example, in block 320, a subsequent pose of the vehicle at the second time (e.g. (t+1)) may be determined using a Bayesian filter. The Bayesian filter may comprise an EKF, which may predict the subsequent pose of the vehicle (e.g. at a second time (t+1)) based, at least in part, on the corrected 6-DOF pose 319 of the vehicle at the first time (t). The EKF prediction for current time (t) may also be viewed depending on a prior pose determination (at time (t−1)).

In some embodiments, an EKF model for body frame correction may initially assume that R′_{nb} is perpendicular to the local plane so that

$$\hat{w} = {v}_{3} {R}_{n b}^{′} [ \begin{matrix}0 \\ 0 \\ 1\end{matrix} ] = 1 \qquad ( 1 )$$

where

$${R}_{n b}^{′} [ \begin{matrix}0 \\ 0 \\ 1\end{matrix} ]$$

represents the third column of the body frame vertical axis.

A pseudo-measurement w=1 may be set, so that for the EKF, the plane normal constraint may be expressed as

$$w - \hat{w} = 1 - {v}_{3} {R}_{n b}^{′} [ \begin{matrix}0 \\ 0 \\ 1\end{matrix} ] \qquad ( 2 )$$

The body frame orientation angle vector θ(t) at a time t may then be obtained based on the body frame orientation angle vector θ(t−1) at a time (t−1) using standard EKF updates as

θ(t)=θ(t−1)+Kₘ(w−ŵ) (3)

where Kₘ is the Kalman gain.

Referring to FIG. 3B, in block 320, the Bayesian filter (e.g. EKF) may output the Bayesian 6-DOF pose 321, which represents the pose of the vehicle (e.g. ego vehicle 130) at a time t. Bayesian 6-DOF pose 321 at time t may depend on the Bayesian 6-DOF pose at time (t−1) and the corrected 6-DOF pose 319 at time t.

In some embodiments, the corrected 6-DOF pose of the vehicle may be provided to a Visual Inertial Odometry (VIO) system (e.g. to block 305 for a subsequent iteration at a second time (t+1)). The VIO system may use the corrected 6-DOF pose in a subsequent iteration.

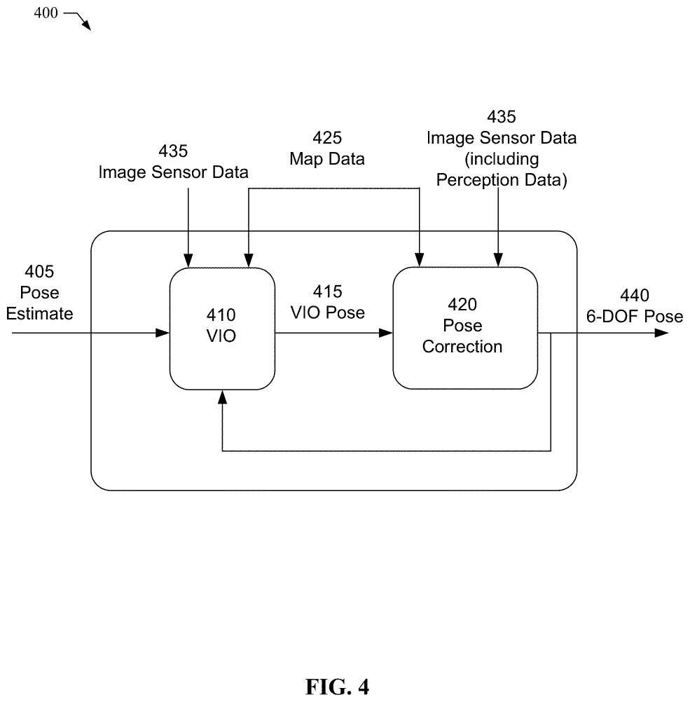

FIG. 4 depicts an exemplary architecture of a system 400 to facilitate vehicle pose determination in accordance with some disclosed embodiments. In some embodiments, system 400 may include VIO engine (VIOE) 410, which may use pose estimate 405 to determine VIO pose 420. Pose Correction engine (CE) 420 may use VIO pose 415 as input and determine 6-DOF pose 440. In some embodiments, system 400 and/or PCE 420 may implement some or all of method 300. In some embodiments, portions of system 400 may be implemented using processor(s), memory, communication and networking functions, and/or other sensors (e.g. image sensors) on ego vehicle 130.

In some embodiments, pose estimate 405 may include a 6-DOF pose determined based on one or more of: GNSS position, WWAN/WLAN position, and/or 6-DOF pose 440 from a prior iteration (e.g. at time t−1), which may be fed back to VIO engine 410 (e.g. at time t). In some embodiments, VIOE 410 may receive image sensor data 435 from image sensors on ego vehicle 130. In some embodiments, VIOE 410 may also receive map data 425. Map data 425 may include information about landmarks visible from a roadway, which may be correlated with image sensor data and used to refine the pose estimate 405. VIO engine 410 may output VIO pose 415. In some embodiments, map data 425 may include HD map data.

In some embodiments, PCE 420 may use image sensor data 435 to correct VIO pose 415 and determine corrected 6-DOF pose 440. Image sensor data 435 may include perception data. Perception data may include information about lane-boundary markers, lanes, and additional information (e.g. features or objects such as traffic signs, traffic signals, highway signs, mileposts, etc.) in images captured by image sensors on ego vehicle 130. In some embodiments, image sensor data 435 may be processed using various image processing techniques to identify features, lane boundaries, objects, etc. in various captured images and the identified features (e.g. lane boundaries, objects etc.) may form perception data, provided to PCE 420.

In some embodiments, PCE 420 may determine a lane plane (e.g. proximate to a current location of ego vehicle 130) associated with a roadway (e.g. roadway 240/lane 247) that ego vehicle 130 is travelling on. In some embodiments, PCE 420 may correct a vertical position of ego vehicle 130 based on the determined lane plane (e.g. as in blocks 305 and 310 in FIG. 3).

In some embodiments, based on the determined lane plane, PCE 420 may determine a corrected altitude (e.g. as in block 315 in FIG. 3). Further, based on the determined lane plane, PCE 420 may determine rotational parameters, which may be used to obtain corrected 6-DOF pose 440 relative to a global or geographic reference frame such as an ENU reference frame (e.g. as in block 318 in FIG. 3). In some embodiments, corrected 6-DOF pose 440 may be output (e.g. to an autonomous drive system) in ego vehicle 130. In some embodiments, as outlined above, corrected 6-DOF pose 440 may be fed back to VIOE 410 as a corrected pose for use in a subsequent iteration.

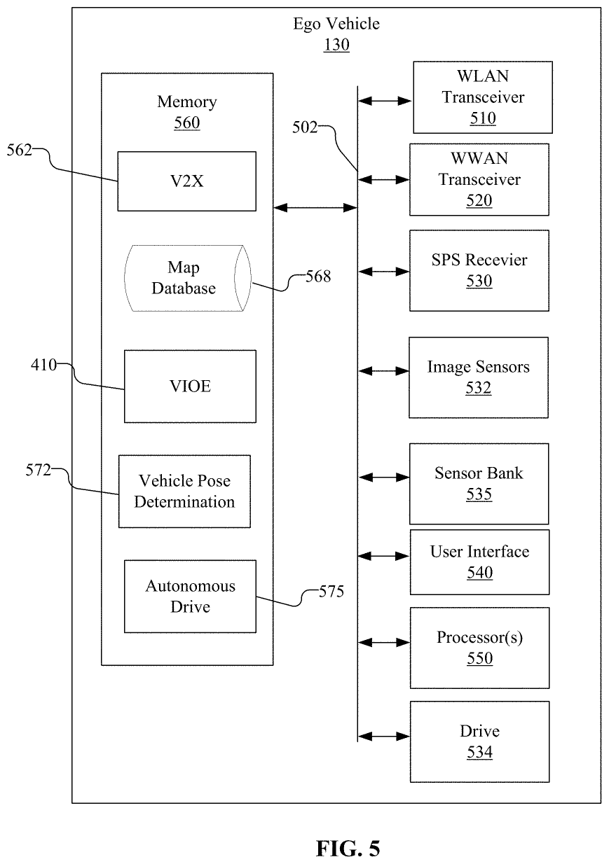

FIG. 5 is a diagram illustrating an example of a hardware implementation of an ego vehicle 130 capable of pose determination, V2X communications, and autonomous or partial autonomous driving. In some embodiments, ego vehicle 130 may implement method 300.

Ego vehicle 130, for example, may include a Wireless Wide Area Network (WWAN) transceiver 520, including a transmitter and receiver, such as a cellular transceiver, configured to communicate wirelessly with AS 210 and/or AS 230 and/or cloud services. The WWAN communication may occur via base stations (e.g. RSU 122 and/or BS 224) in wireless network 120. As outlined above, AS 210 and/or AS 230 and/or cloud-based services (e.g. associated with AS 210/ AS 230) may provide ADS related information, including ADS assistance information, which may facilitate ADS decision making. ADS assistance information may include map information including HD map information and/or location assistance information. WWAN transceiver 520 may also be configured to wirelessly communicate directly with other V2X entities, e.g., using wireless communications under IEEE 802.11p on the ITS band of 5.9 GHz or other appropriate short range wireless communications. Ego vehicle 130 may further include a Wireless Local Area Network (WLAN) transceiver 510, including a transmitter and receiver, which may be used for direct wireless communication with other entities, including V2X entities, such as other servers, access points, and/or other vehicles 104.

Ego vehicle 130 may further include SPS receiver 530 with which SPS signals from SPS satellites (e.g. SVs 180) may be received. Satellite Positioning System (SPS) receiver 530 may be enabled to receive signals associated with one or more SPS/GNSS resources such as SVs 180. Received SPS/GNSS signals may be stored in memory 560 and/or used by processor(s) 550 to determine a position of ego vehicle 130. In some embodiments, SPS receiver 530 may include a code phase receiver and a carrier phase receiver, which may measure carrier wave related information. The carrier wave, which typically has a much higher frequency than the pseudo random noise (PRN) (code phase) sequence that it carries, may facilitate more accurate position determination. The term “code phase measurements” refer to measurements using a Coarse Acquisition (C/A) code receiver, which uses the information contained in the PRN sequence to calculate the position of ego vehicle 130. The term “carrier phase measurements” refer to measurements using a carrier phase receiver, which uses the carrier signal to calculate positions. The carrier signal may take the form, for example for GPS, of the signal L1 at 1575.42 MHz (which carries both a status message and a pseudo-random code for timing) and the L2 signal at 1227.60 MHz (which carries a more precise military pseudo-random code). In some embodiments, carrier phase measurements may be used to determine position in conjunction with code phase measurements and differential techniques, when GNSS signals that meet quality parameters are available. The use of carrier phase measurements along with differential correction can yield relative sub-decimeter position accuracy.

Ego vehicle 130 may further include image sensors 532 and sensor bank 535. Image sensors 532 may include cameras, CCD image sensors, or CMOS image sensors, computer vision devices, lidar, etc. mounted at various locations on ego vehicle 130 (e.g. front, rear, sides, top, corners, in the interior, etc.). Image sensors 532 may form part of a VIO system on ego vehicle 130. The VIO system may be implement using specialized hardware, implemented using software, or some combination of hardware, software, and firmware. Image sensors 532 may be used to obtain images of targets, which may include landmarks, lane markers, lane boundaries, traffic signs, mileposts, billboards, etc. that are in the vicinity (e.g. within visual range) of ego vehicle 130. In some embodiments, mage sensors may include depth sensors, which may be used to estimate range to one or more targets and/or estimate dimensions of targets. The term depth sensor is used broadly to refer to functional units that may be used to obtain depth information including: (a) RGBD cameras, which may capture per-pixel depth information when the depth sensor is enabled; (b) stereo sensors such as a combination of an infra-red structured light projector and an infra-red camera registered to a RGB camera; (c) stereoscopic cameras capable of capturing 3D images using two or more cameras to obtain depth information for a scene; (d) lidar; etc. In some embodiments, image sensor(s) 532 may continuously scan the roadway and provide images to processor(s) 550 along with information about corresponding image sensor pose and other parameters. In some embodiments, processor(s) 560 may trigger the capture of one or more images of the roadway and/or of the environment around ego vehicle 130 using commands over bus 502.

Sensor bank 535 may include various sensors such as one or more of: IMUs, ultrasonic sensors, ambient light sensors, radar, etc., that may be used for ADS assistance and autonomous or partially autonomous driving. Ego vehicle 130 may also include drive controller 534 that is used to control ego vehicle 130 for autonomous or partially autonomous driving. Ego vehicle 130 may include additional features, such as user interface 540 that may include e.g., a display, a keypad or other input device, such as a voice recognition/synthesis engine or virtual keypad on the display, through which the user may interact with the ego vehicle 130 and/or with an ADS associated with ego vehicle 130. Drive controller may receive input from processor(s) 550, sensor bank 535, and/or image sensors 532.

Ego vehicle 130 may include processor(s) 550 and memory 560, which may be coupled to each other and to other functional units on ego vehicle 130 using bus 502. In some embodiments, a separate bus, or other circuitry may be used to connect the functional units (directly or indirectly). In some embodiments, processor(s) 550 may be implemented within one or more application specific integrated circuits (ASICs), digital signal processors (DSPs), image processors, digital signal processing devices (DSPDs), programmable logic devices (PLDs), field programmable gate arrays (FPGAs), central processing units (CPUs), neural processing units (NPUs), vision processing units (VPUs), controllers, micro-controllers, microprocessors, electronic devices, other electronic units designed to perform the functions described herein, and/or a combination thereof. Memory 560 may contain executable code or software instructions that when executed by the processor(s) 550 cause the processor(s) 550 to operate as a special purpose computer programmed to perform the techniques disclosed herein.

As illustrated in FIG. 5, the memory 560 may include program code, components, or modules that may be implemented by the processor(s) 550 to perform the methodologies described herein. While the code, components, or modules are illustrated, in FIG. 5, as software in memory 560 that is executable by the processor(s) 550, it should be understood that the code, components, or modules may be dedicated hardware either as part of processor(s) 550 or implemented as physically separate hardware. In general, VIOE 410, Vehicle Position Determination (VPD) 572, and Autonomous Drive (AD) 575 may be implemented using some combination of hardware, software, and/or firmware.

In some embodiments, processor(s) 550 may implement method 300, VIOE 410 and/or PCE 420. In some embodiments, method 300 may form part of VPD 572. For example, processor(s) 550 may implement method 300, VIOE 410, and/or PCE 420 using map data 425, image sensor data 435, and/or position related information (e.g. as determined based on information received from one or more of SPS Receiver 530, WLAN Transceiver 510, and/or WWAN transceiver 520). Map data 425 may include information from map database (MDB) 568 and/or map related information received using WLAN Transceiver 510, and/or WWAN transceiver 520. Image sensor data may include perception data and may be captured by image sensors 532. In some embodiments, processor(s) 550 may use images from image sensor 532 and map information in MDB 568, at least in part, to perform the functions of VIOE 410 and determine VIO pose 415.

Further, processor(s) 550 may refine and/or correct VIO pose 415 using map data (e.g. from MDB 568) and perception data (e.g. derived from image sensor data 435 captured by image sensors 532) using VIOE 410. For example, perception data may be obtained by processing images (e.g. using VIOE code 410) to detect lane-boundary markers, lanes, objects, features, signs, mileposts, billboards, and/or other landmarks along a roadway. VIOE code 410 may include program code to process images captured by image sensors 532 to identify objects, features, lane-boundary markers, lanes, mileposts, signs, billboards, and/or other landmarks. VIOE code 410 may be executed by processor(s) 550.

In some embodiments, vehicle pose determination (VPD) 572 may include program code to determine and/or correct vehicle pose. In some embodiments, VPD 572 may be executed by processor(s) 550. For example, at a current time t, one or more of: (a) image sensor data 435 (including perception data) captured by image sensors 532; (b) map data 425 (e.g. from MDB 568 and/or received using WWAN transceiver 520/WLAN transceiver 510); (c) a GNSS position estimate (e.g. based on signals received by SPS Receiver 520) and/or (d) a position estimate from a prior iteration (e.g. at a time t−1) may be used (e.g. by a processor(s) 550 executing VPD 572) to determine a first 6-DOF pose of ego vehicle 130. In some embodiments, the first 6-DOF pose may comprise a first altitude and one or more first rotational parameters that determine an orientation of the first vehicle relative to a reference frame.

In some embodiments, a lane plane associated with a current location of ego vehicle 130 may be determined (e.g. by a processor(s) 550 executing VPD 572). In some embodiments, the lane plane may be determined based on the first 6-DOF pose and locations corresponding to a plurality of lane-boundary markers on the roadway, wherein the locations corresponding to each of the lane-boundary markers are determined from a map based on the reference frame.

The determined lane plane may be used to determine an updated altitude of ego vehicle 130 (e.g. by a processor(s) 550 executing VPD 572). Based on the determined lane plane, the first position estimate, and the updated altitude of ego vehicle 130, a corrected 6-DOF pose 440 of ego vehicle 130 may be determined (e.g. by a processor(s) 550 executing VPD 572 as outlined above with respect to method 300).

In some embodiments, MDB 568 may hold map data including HD maps. The maps may include maps for a region around a current location of ego vehicle 130 and/or maps for locations along a route being driven by ego vehicle 130. Maps may be received from a V2X entity, and/or over WLAN/WWAN. In some embodiments, the maps may be loaded in MDB 568 based on a planned route, prior to start of a trip. In some embodiments, HD maps in MDB 568 may include information about lanes, lane-boundary markers, landmarks, highway signs, traffic signals, traffic signs, mileposts, objects, features, etc. that may be useful for position determination. In some embodiments, MDB 568 may include maps at different levels of granularity. For example, a less detailed map, which may include major landmarks, may be provided to VIOE 410 (e.g. for determination of VIO pose 415), while a detailed (e.g. HD) map with detailed information about lane-boundary markers, lanes etc. may be provided to PCE 420. In some embodiments, frequently used maps or maps likely to be used along a planned route may be cached.

Memory 560 may include a V2X code 562 that when implemented by the processor(s) 550 configures the processor(s) 550 to cause the WWAN transceiver 520 or WLAN transceiver 510 to wirelessly communicate with V2X entities, such as AS 210 and/or AS 230 and/or cloud services, RSU 222, and/or BS 224. V2X unit 562 may enable the processor(s) 550 to transmit and receive V2X messages to and from V2X entities, such as AS 110 and/or AS 130 and/or cloud services e.g., with payloads that include map information, e.g., as used by processor(s) 550 and/or AD 575.

Memory 560 may include VPD 572, which when implemented by the processor(s) 550 configures the processor(s) 550 to perform method 300, determine a 6-DOF pose, request maps, and/or request, receive, and process ADS assistance from AS 210 and/or AS 230 via the WWAN transceiver 520 or WLAN transceiver 510.

As illustrated, memory 560 may include additional executable autonomous driving (AD) code 575, which may include software instructions to enable autonomous driving and/or partial autonomous driving capabilities. For example, processor(s) 550 implementing AD 575 may use a determined 6-DOF pose 440 to implement lane changes, correct heading, etc. Based on one or more of the above parameters, processor(s) 550 may control drive controller 534 of the ego vehicle 130 for autonomous or partially autonomous driving. Drive controller 534 may include some combination of hardware, software, and firmware, actuators, etc. to perform the actual driving and/or navigation functions.

In some embodiments, ego vehicle 130 may include means for obtaining one or more images, including images of an environment around ego vehicle (e.g. traffic signs, mile posts, lane-boundary markers, billboards, etc.). The means for obtaining one or more images may include image sensor means. Image sensor means may include image sensors 632 and/or the one or more processors 650 (which may trigger the capture of one or more images).

In some embodiments, ego vehicle 130 may include means for determining 6-DOF poses of ego-vehicle 130, which may include one or more of SPS receiver 530, image sensors 532, sensor bank 535 (which may include IMUs), WWAN transceiver 510, WLAN transceiver 520 and processor(s) 550 with dedicated hardware or implementing executable code or software instructions in memory 660 such as VIOE 410 and/or VPD 572 using information in map database 568.

In some embodiments, ego vehicle 130 may include means for determining a lane plane (e.g. associated with a roadway being travelled by the vehicle), which may include one or more of image sensors 532 (e.g. to capture images of lane boundary markers), sensor bank 535 (e.g. to sense lane boundary markers), and processor(s) 550 with dedicated hardware or implementing executable code or software instructions in memory 660 such as VPD 572 using information in map database 568 (which may provide locations corresponding to lane-boundary markers).

In some embodiments, ego vehicle 130 may include means for determining a corrected altitude of the vehicle, which may include processor(s) 550 with dedicated hardware or implementing executable code or software instructions in memory 660 such as VPD 572 using information in map database 568 (e.g. pertaining to the lane/lane-boundary markers).

In some embodiments, ego vehicle 130 may include means for determining a corrected 6-DOF pose of the vehicle, which may include processor(s) 550 with dedicated hardware or implementing executable code or software instructions in memory 660 such as VPD 572.

The methodologies described herein may be implemented by various means depending upon the application. For example, these methodologies may be implemented in hardware, firmware, software, or any combination thereof. For a hardware implementation, the processor(s) 550 may be implemented within one or more ASICs, DSP), image processors, DSPDs, PLDs, FPGAs, CPUs, NPUs, VPUs, processors, controllers, micro-controllers, microprocessors, electronic devices, other electronic units designed to perform the functions described herein, or a combination thereof In some embodiment, processor(s) 550 may include capability to detect landmarks, lane-boundary markers, highway signs, traffic signs, traffic signals, mileposts, objects, features, etc. in images and correlate the features with corresponding features in a map (e.g. such as an HD map). In some embodiments, processor(s) 550 may include capability to determine lane boundaries based on lane-boundary markers, determine a lane plane, and perform pose determination and/or pose correction of ego vehicle 130. Processor(s) 550 may also include functionality to perform Optical Character Recognition (OCR) and perform other well-known computer vision and image processing functions such as feature extraction from images, image comparison, image matching etc.

For an implementation of ADS for an ego vehicle 130 involving firmware and/or software, the methodologies may be implemented with modules (e.g., procedures, functions, and so on) that perform the separate functions described herein. Any machine-readable medium tangibly embodying instructions may be used in implementing the methodologies described herein. For example, program code may be stored in a memory (e.g. memory 560) and executed by processor(s) 550, causing the processor(s) 550 to operate as a special purpose computer programmed to perform the techniques disclosed herein. Memory may be implemented within the one or processor(s) 550 or external to the processor(s) 550. As used herein the term “memory” refers to any type of long term, short term, volatile, nonvolatile, or other memory and is not to be limited to any particular type of memory or number of memories, or type of media upon which memory is stored.

If ADS in ego vehicle 130 is implemented in firmware and/or software, the functions performed may be stored as one or more instructions or code on a non-transitory computer-readable storage medium such as memory 560. Examples of storage media include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In some embodiments, instructions and/or data for ego vehicle 130 may be provided via transmissions using a communication apparatus. For example, a communication apparatus on ego vehicle 130 may include a transceiver, which receives transmission indicative of instructions and data. The instructions and data may then be stored on non-transitory computer readable media, e.g., memory 560, and may cause the processor(s) 550 to be configured to operate as a special purpose computer programmed to perform the techniques disclosed herein. That is, the communication apparatus may receive transmissions with information to perform disclosed functions.

Thus, in some embodiments, ego vehicle 130 may include a means for determining a first 6 degrees of freedom (6-DOF) pose of the vehicle relative to a reference frame. For example, inputs one or more of SPS receiver 530, image sensors 532, MDB 568, WWAN transceiver 520, and/or WLAN transceiver 510, and/or portions of VPD 572, and/or processor(s) 550, with dedicated hardware or implementing executable code or software instructions in memory 560 may be used to determine a first 6 degrees of freedom (6-DOF) pose of ego vehicle 130. In some embodiments, ego vehicle 130 may further include means for identifying a lane plane associated with a roadway being travelled by ego vehicle 130. For example, inputs from one or more of image sensors 532, MDB 568, portions of VPD 572, and/or processor(s) 550, with dedicated hardware or implementing executable code or software instructions in memory 560 may be used to identify a lane plane associated with a roadway being travelled by ego vehicle 130. In some embodiments, ego vehicle 130 may further include a means for determining a corrected altitude of the vehicle and/or means for determining a corrected 6-DOF pose of the vehicle. For example, inputs from one or more of MDB 568, portions of VPD 572, and/or processor(s) 550, with dedicated hardware or implementing executable code or software instructions in memory 560 may be used to determine a corrected altitude of the vehicle and/or determine a corrected 6-DOF pose of the vehicle.

Although the disclosure is illustrated in connection with specific embodiments for instructional purposes, the disclosure is not limited thereto. Various adaptations and modifications may be made without departing from the scope Therefore, the spirit and scope of the appended claims should not be limited to the foregoing description.

What is claimed is:

1. A method for vehicle positioning, the method comprising:
determining, at a first time, a first 6 degrees of freedom (6-DOF) pose of a vehicle, wherein the first 6-DOF pose comprises a first altitude and one or more first rotational parameters indicative of a first orientation of the vehicle relative to a reference frame;
determining a lane plane associated with a roadway being travelled by the vehicle, wherein the lane plane is determined based on the first 6-DOF pose and lane-boundary marker locations of a plurality of lane-boundary markers on the roadway, wherein, for each lane-boundary marker of the plurality of lane-boundary markers, the corresponding lane-boundary marker location is determined from a map, wherein the map is based on the reference frame; and
determining a corrected altitude of the vehicle based on the lane plane.

2. The method of claim 1, wherein the corrected altitude of the vehicle is determined by projecting the first altitude onto the lane plane.

3. The method of claim 1, further comprising:
determining, at the first time, a corrected 6-DOF pose of the vehicle based on the corrected altitude of the vehicle, the first 6-DOF pose, and an axis normal to the lane plane.

4. The method of claim 3, wherein determining the corrected 6-DOF pose of the vehicle comprises:
determining one or more second rotational parameters indicative of a second orientation of the vehicle relative to the reference frame.

5. The method of claim 4, wherein the one or more second rotational parameters are determined using a Gram-Schmidt technique based, at least in part, on the axis normal to the lane plane.

6. The method of claim 3, further comprising:
determining a subsequent 6-DOF pose of the vehicle at a second time subsequent to the first time, based, at least in part, on the corrected 6-DOF pose of the vehicle at the first time.

7. The method of claim 6, wherein determining the subsequent pose of the vehicle at the second time comprises:
determining the subsequent pose using a Bayesian filter.

8. The method of claim 7, wherein the Bayesian filter comprises an Extended Kalman Filter (EKF) and determining the subsequent pose of the vehicle comprises:
predicting, using the EKF filter, the subsequent pose of the vehicle based, at least in part, on the corrected 6-DOF pose of the vehicle at the first time.

9. The method of claim 3, further comprising:
providing the corrected 6-DOF pose of the vehicle as input to a Visual Inertial Odometry (VIO) system coupled to the vehicle.

10. The method of claim 1, wherein the plurality of lane-boundary markers comprise three or more lane-boundary markers.

11. The method of claim 1, wherein the plurality of lane-boundary markers comprise right lane-boundary markers and left lane-boundary markers relative to a direction of travel of the vehicle.

12. The method of claim 1, wherein an area bounded by the plurality of lane-boundary markers exceeds an area threshold.

13. The method of claim 1, wherein the first 6-DOF pose of the vehicle is determined based on one or more of: a Global Navigation Satellite System (GNSS) position, Visual Inertial Odometry (VIO), or a combination thereof.

14. A vehicle comprising:
a Visual Inertial Odometry (VIO) system comprising an image sensor,
a Satellite Positioning System (SPS) receiver,
a memory, and
a processor coupled to the VIO system, SPS receiver, and memory, wherein the processor is configured to:
determine, at a first time, a first 6 degrees of freedom (6-DOF) pose of the vehicle, wherein the first 6-DOF pose comprises a first altitude and one or more first rotational parameters indicative of a first orientation of the vehicle relative to a reference frame;
determine a lane plane associated with a roadway being travelled by the vehicle, wherein the lane plane is determined based on the first 6-DOF pose and lane-boundary marker locations of a plurality of lane-boundary markers on the roadway, wherein, for each lane-boundary marker of the plurality of lane-boundary markers, the corresponding lane-boundary marker location is determined from a map, wherein the map is based on the reference frame; and
determine a corrected altitude of the vehicle based on the lane plane.

15. The vehicle of claim 14, wherein the corrected altitude of the vehicle is determined by projecting the first altitude onto the lane plane.

16. The vehicle of claim 14, wherein the processor is further configured to:
determine, at the first time, a corrected 6-DOF pose of the vehicle based on the corrected altitude of the vehicle, the first 6-DOF pose, and an axis normal to the lane plane.

17. The vehicle of claim 16, wherein to determine the corrected 6-DOF pose of the vehicle, the processor is configured to:
determine one or more second rotational parameters indicative of a second orientation of the vehicle relative to the reference frame.

18. The vehicle of claim 17, wherein the one or more second rotational parameters are determined using a Gram-Schmidt technique based, at least in part, on the axis normal to the lane plane.

19. The vehicle of claim 16, wherein the processor is further configured to:
determine a subsequent 6-DOF pose of the vehicle at a second time subsequent to the first time, based, at least in part, on the corrected 6-DOF pose of the vehicle at the first time.

20. The vehicle of claim 19, wherein to determine the subsequent pose of the vehicle at the second time, the processor is configured to:
determine the subsequent pose using a Bayesian filter.

21. The vehicle of claim 20, wherein the Bayesian filter comprises an Extended Kalman Filter (EKF) and to determine the subsequent pose of the vehicle, the processor is configured to:
predict, using the EKF filter, the subsequent pose of the vehicle based, at least in part, on the corrected 6-DOF pose of the vehicle at the first time.

22. The vehicle of claim 16, wherein the processor is further configured to:
providing the corrected 6-DOF pose of the vehicle as input to the VIO system.

23. The vehicle of claim 14, wherein the plurality of lane-boundary markers comprise three or more lane-boundary markers.

24. The vehicle of claim 14, wherein the plurality of lane-boundary markers comprise right lane-boundary markers and left lane-boundary markers relative to a direction of travel of the vehicle.

25. The vehicle of claim 14, wherein an area bounded by the plurality of lane-boundary markers exceeds an area threshold.

26. The vehicle of claim 14, wherein the first 6-DOF pose of the vehicle is determined based on one or more of:
SPS measurements by the SPS receiver; or
VIO measurements based, at least in part, on images captured by the image sensor, or
a combination thereof.

27. A vehicle comprising:
means for determining, at a first time, a first 6 degrees of freedom (6-DOF) pose of the vehicle, wherein the first 6-DOF pose comprises a first altitude and one or more first rotational parameters indicative of a first orientation of the vehicle relative to a reference frame;
means for determining a lane plane associated with a roadway being travelled by the vehicle, wherein the lane plane is determined based on the first 6-DOF pose and lane-boundary marker locations of a plurality of lane-boundary markers on the roadway, wherein, for each lane-boundary marker of the plurality of lane-boundary markers, the corresponding lane-boundary marker location is determined from a map, wherein the map is based on the reference frame; and
means for determining a corrected altitude of the vehicle based on the lane plane.

28. The vehicle of claim 27, further comprising:
means for determining, at the first time, a corrected 6-DOF pose of the vehicle based on the corrected altitude of the vehicle, the first 6-DOF pose, and an axis normal to the lane plane.

29. A non-transitory computer-readable medium comprising instructions to configure a processor to:
determine, at a first time, a first 6 degrees of freedom (6-DOF) pose of a vehicle, wherein the first 6-DOF pose comprises a first altitude and one or more first rotational parameters indicative of a first orientation of the vehicle relative to a reference frame;
determine a lane plane associated with a roadway being travelled by the vehicle, wherein the lane plane is determined based on the first 6-DOF pose and lane-boundary marker locations of a plurality of lane-boundary markers on the roadway, wherein, for each lane-boundary marker of the plurality of lane-boundary markers, the corresponding lane-boundary marker location is determined from a map, wherein the map is based on the reference frame; and
determine a corrected altitude of the vehicle based on the lane plane.

30. The computer-readable medium of claim 29, further comprising instructions to configure the processor to:
determine, at the first time, a corrected 6-DOF pose of the vehicle based on the corrected altitude of the vehicle, the first 6-DOF pose, and an axis normal to the lane plane.
